(19) United States
(12) Patent Application Publication
(10) Pub. No.: US 2002/0179522 A1
(43) Pub. Date: Dec. 5, 2002

(54) Sintered metal HEPA filter to block release of mercury

(76) Inventors: Terrance D. Phillips, Aiken, SC (US); Rahn H. Ross, Aiken, SC (US)

Correspondence Address: NEXSEN PRUET JACOBS & POLLARD LLC., PO Box 10107, Greenville, SC, 29603, US

(21) Appl. No.: 09/814,438

(22) Filed: Mar. 22, 2001

(51) Int. Cl. B01D 46/00

(52) U.S. Cl. 210/510.1; 96/233

(57) ABSTRACT

The invention is a high efficiency particulate (HEPA) filter apparatus and system for the removal of mercury from a gaseous stream, and method for assaying the mercury removed. The HEPA filter provides for capture of mercury at a rate of over seven times the rate of removal for HEPA filters known to the art. The invention provides a filter system that can be cleaned and regenerated in situ.

### STATEMENT OF GOVERNMENT RIGHTS

The U.S. Government has rights in this invention pursuant to Contract No. DE-5 AC09-89-SR18035 between the U.S. Department of Energy and Westinghouse Savannah River Company.

### FIELD OF THE INVENTION

This invention relates generally to a high efficiency particulate (HEPA) filter capable of filtering submicron particulates, and more particularly to a HEPA filter apparatus and method of filtering mercury from an exhaust stream. The filter of the current invention can be cleaned and regenerated in situ.

### BACKGROUND OF THE INVENTION

References to HEPA filters herein are references to filters and/or filter systems capable of and routinely required to pass smoke testing demonstrating the removal from a fluid stream of about 99.97% of 0.3 micrometer (0.3 μ) dioctylphthalate (DOP) monodispersed particles. This is a standard definition familiar to those of skill in the art.

High Efficiency Particulate (HEPA) filters have been utilized for filtration of submicron particles from exhaust gas streams, and especially for the filtration of radioactive particles from exhaust gasses.

To date, makers and users of HEPA filters have focused on the development of filters that generate very low pressure drops in the course of removing particulate matter from the fluid stream.

Low pressure drop has been thought to be necessary and advantageous because it requires only a relatively low power blower (or evacuator) system, and places little mechanical stress on the filter and on the filter support or framing structure. A consequence of requiring a low pressure drop, however, is a relatively low filtration rate measured, e.g., in cubic feet per minute. To compensate for these low flow-through rates, various configurations of filters and systems have been advanced to increase the overall flow rate by increasing the effective surface area of the filter. Thus, configurations such as accordion-folded, pleated, or other techniques have been suggested, each designed to enlarge the usable filter surface area while complying with space and other constraints imposed by the overall system.

Another problem faced by users of HEPA filters, and particularly users filtering exhaust gas streams from nuclear facilities, is filter life. Filter life is defined and determined with reference to a given filter's continued ability to provide sufficient fluid flow rates while continuing to prevent passage of the particulates to be filtered. For many industries and uses, the end of life for a HEPA filter constitutes a major expense and disposal problem. A filter in a nuclear facility, for example, is costly to replace in terms of time, manpower, and materials, including the temporary loss of use of the exhaust stream path. It also may pose a hazard due to the particulates entrapped or adhered to the filter, creating risks to personnel and a need for long term storage and disposal. Thus, extending the useful life of a HEPA filter presents a major saving in resources and safety to such facilities.

One approach to extending the life of a filter has been to provide means of cleaning or washing the filter, either in situ or upon removing the filter from its frame or mounting. The systems, methods, and apparatus known to date, however, each involve relatively complicated procedures or mechanisms, which are expensive and themselves liable to failures and breakdowns.

The systems are subject to the parameters of the overall system, meaning that they must each work in a low pressure drop system. Other solutions include using modular components, allowing the filter to be taken off-line and cleaned. This too is highly expensive, and does not increase the expected life of each given filter, meaning that no real savings are achieved.

In Zeller, U.S. Pat. No. 5,487,771, a high efficiency metallic membrane of sintered nickel powder is disclosed. The membrane is sandwiched inside a frame, with improved porosity and gas throughput offered by the filter. In Layton, U.S. Pat. Nos. 5,238,477 and 5,158,586, HEPA filter units are disclosed having metallic membranes of continuous metal sheet accordion-folded to filter out submicron particles. The filters are resistant to elevated temperatures and are composed of stainless steel and other metals. In Davis, U.S. Pat. No. 5,114,447, an ultra-high efficiency particulate air filter is disclosed which is composed of multiple, porous, sintered metal filter discs manufactured from stainless steel, nickel and nickel alloys. The filter discs are enclosed permanently within a cylindrical casing, and the filter discs are resistant to high temperatures and pressures.

In Dillmann, et al., U.S. Pat. No. 4,865,803, a pressurized gas discharge filtration system is disclosed which includes stainless steel fiber filter packs aligned in multiple stages. The fiber filter packs are resistant to high temperatures. In Iniotakis, et al., U.S. Pat. No. 4,655,797, a microporous metallic membrane screen is disclosed for filtration of corrosive gas streams. The metallic membrane screens have metals such as gold or platinum catalytically deposited on the metal screens to provide corrosion resistance. In Komatsu, et al., U.S. Pat. No. 4,584,004, a chamber of particulate filters is disclosed, with the filters made of organic fiber material. A chamber is provided containing back-flushing nozzles for pulsed air cleaning of particulates entrapped inside the fiber filters.

In Weichselbaum, et al., U.S. Pat. 3,933,652, a process is disclosed for manufacturing a stainless steel filter for use in medical infusion equipment. The filter is made of sintered stainless steel particles, and is sealed inside a tubular fitting. In Spulgis, U.S. Pat. No. 3,881,899, an apparatus for dislodging particulates from a rechargeable filter is disclosed, where the filter is placed inside the apparatus, and the particles are removed from the filter using a pneumatic air delivery apparatus. The filter material in the particulate filter is finely divided activated charcoal.

In Seibert et al., U.S. Pat. No. 5,358,552, a process is disclosed for introducing a backwash liquid. The backwash liquid is forced through the filter in the direction opposite the normal flow of the stream to be filtered (in an upstream direction). The purpose is to flush the filter by forcing trapped particulates out of the filter in the direction from which the particulates became entrained in the filter media, thus cleaning the filter.

These and other prior filters have a variety of shortcomings. Some of them, while capable of relatively full cleaning, are incapable of achieving HEPA standards and/or of withstanding the required operating environment. Others are incapable of being cleaned, or at least cannot be cleaned to even a relatively high percentage of full flow and filtering ability. Others must simply be replaced, while many cannot be cleaned in situ. Of those that can be cleaned in situ, they require very complicated backflushing mechanism, requiring not only the installation of additional components, but requiring the installation of complicated recovery systems.

Another problem with the HEPA filters known to the art is that they are incapable of capturing all of the particulates of interest. One such particulate is mercury, present in many exhaust streams. Current means known to the art for removing mercury from a fluid stream utilize chemical or catalyst-type material. For example, in U.S. Pat. No. 4,139,354 to Giles, it is proposed to remove mercury from a gas stream through the use of filter having an iodine impregnated charcoal medium. The mercury is absorbed by the charcoal as the stream passes through the medium. Other media known to the art for this purpose include activated charcoal, charcoal prepared from coconut shells, diatomaceous earths and activated alumina. Another means for removing mercury is to pass the stream through a fibrous medium, wherein the fibers are coated with a noble metal such as silver.

One problem with mercury filters of the type described is that the media eventually becomes saturated and must be replaced. That is, there is no known method of regenerating these media in situ. When the medium becomes saturated, the filter and hence the entire exhaust stack, must be taken off line for replacement of the medium. Moreover, filters of this type are not acceptable for many uses, such as use in an exhaust stack. The requirements of pressure drop, air flow rate, and conditions such as temperature make the use of such filters in the exhaust stack environment problematic.

There is thus a need in the art for a HEPA filter that is capable of providing the required filtration, including removal of mercury, and is resistant to damage, that can be cleaned repeatedly in situ at low cost and low complexity, that can be cleaned and restored to full filtering capability at the pressure drop required, and that will allow recovery of the removed particulates for reclamation and/or analysis.

### SUMMARY OF THE INVENTION

It is an object of this invention to provide a HEPA filter that filters submicron airborne particles from exhaust gas streams.

It is a further object of this invention to provide a HEPA filter that filters radioactive particles at a high efficiency from exhaust gas streams.

It is another object of this invention to provide a HEPA filter that will remove mercury from the fluid stream. It is moreover an object of this invention to provide a HEPA filter and system by which the filter can be restored to full flow and filtration capability by in situ cleaning, including removal of the trapped mercury.

It is a more particular object of this invention to provide a HEPA filter that is washable in situ by cleaning with a liquid such as water or such as acids particularly suited to removal of particulates, the liquid being used on the influent side of the filter.

It is likewise an object of this invention to provide a HEPA filter that can be spray washed, after which it can be restored to full flow and filtration capability by application of a hard vacuum providing a high pressure drop.

It is another object of this invention to provide a HEPA filter capable of the cleaning and restoration referred to above while also being resistant to high temperature environments as in melters and incinerators.

These and other objects of the invention are accomplished by providing a filter system for removing particulates including mercury from an air stream, the system having a HEPA filter comprising a thin sheet formed of sintered particles, the particles having a size of approximately 1.0μ, the filter having an influent side and an effluent side; a cleaning system for the filter, the cleaning system comprising means for spraying said influent side of said filter with a fluid; and means for creating a high pressure drop across said filter. The HEPA filter is resistant to high pressure drops across the filter plate, and does not degrade in high temperature conditions. The apparatus described provides for an improved method to collect mercury on the influent surface of the filter by the use of very small pore diameters through the HEPA filter, while providing a noncorrosive filter media that is washable in situ.

Thus, the objects of the invention are also accomplished by providing a method for periodic monitoring of a gas stream using an in situ filter system, said method comprising providing an in situ filter system for said stream, said system comprising: a HEPA filter, said filter having an influent side and an effluent side, said influent side having an effective pore size of about 0.2 μ; means for cleaning said filter by directing a fluid against said influent side of said filter to remove particulates therefrom; and means for collecting said fluid and said particulates; periodically activating said means for cleaning; collecting said fluid and said particulates from said means for collecting; and analyzing said particulates to monitor said gas stream.

### BRIEF DESCRIPTION OF THE DRAWINGS

Various other features and advantages will become apparent from a reading of the following detailed description, given with reference to the various figures of drawing, in which:

FIG. 1 is a depiction of a preferred embodiment of a HEPA filter and system according to the invention.

FIG. 2 is a diagrammatic depiction of a test apparatus for comparing filtering capabilities.

FIG. 3 is a depiction of an alternate preferred embodiment of a HEPA filter and system according to the invention.

### DETAILED DESCRIPTION

In accordance with this invention, it has been found that high efficiency filters are required to remove radioactive particulates from exhaust gas streams from areas contaminated with radiation.

It is desirable to capture 99.97% or greater of particulates or aerosol particles of the size of 0.3 micrometer aerodynamic diameter (AED) or larger, by the use of high efficiency particulate (HEPA) filters. The filters must be capable of withstanding high temperatures from heated exhaust gas flow, and high air flow pressures through the filter over extended periods of time.

As explained above, it is the current state of the art to use fibers to form HEPA filters. The fibers may be of organic or inorganic material, and may be sintered metal fibers. Such construction leads to the use of low pressure (vacuum) systems. These systems have the advantage of requiring little power for the evacuation process, and the presence of low mechanical stress on the filters. As a consequence, however, the amount of fluid, per unit area, that can be filtered is relatively small. Efforts to improve this factor have lead to pleated and folded filter media.

Another problem with the use of fibers is that when even metal or glass fiber filters are wetted, they become effectively plugged. It is speculated that, given the small pore sizes of HEPA filters, simple surface tension prevents the liquid from being pulled through the fibers. This problem is particularly compounded where the filters have already collected particulates.

Tests at the Westinghouse Savannah River Company have shown that, once wetted, state of the art HEPA filters cannot be unplugged even by the application of a vacuum as high as 105 kPa (421 inches water column). Instead, the filters must simply be allowed to passively dry completely before being used again.

Cleaning HEPA filters known to the art has so far been accomplishing only by backwashing with a fluid. Backwashing removes particulates that have been entrained into the mesh of the fibers of the filter. Backwashing requires either removing the filter from the system, or installing in the system a complicated series of valves, piping, and other apparatus necessary to accomplish the backwashing.

In pending U.S. patent application Ser. Number 09/358,782, assigned to the assignee of the current invention, there is disclosed a HEPA filter suitable for use in exhaust stacks. The filter is a sintered material having a thickness in the range of from about 0.033 cm to about 0.12 cm (0.013 to 0.047 inches) formed by sintering particles or pellets having a diameter of about one micron (1.0 μ). It is preferred that the particles be of stainless steel, thus providing a media having good mechanical strength, resistance to high temperatures, and good chemical resistance. Such a media for HEPA filters is a radical departure from the current state of the art, not only in using pellets instead of fibers, but also because this media requires the use of a very high vacuum during normal operation. A HEPA filter so constructed requires a standard operating vacuum of about 40 kPa (160 inches water column) to achieve a gas flowthrough rate of about 0.00017 cubic meters per 0.006 square meters of media area (0.35 cfm per square inch). An operating vacuum of this magnitude would destroy standard HEPA filter media.

Also, the media permits cleaning by application of fluid to only the influent side of the filter, effectively washing off the particulates. It is speculated that such washing of the influent side, as opposed to backwashing or other methods, is made possible because particulates do not become entrained in the mesh of the media, but are trapped on the surface of the media. Because the particulates are not entrained, a fluid stream easily washes the particulates off.

A surprising aspect of the invention is then the restoration of the filter, or regeneration, following the washing. Although wetted, the media of the current invention can be restored to full flowthrough by the application of a vacuum on the order of 105 kPa (421 inches water column).

This exceedingly high pressure drop removes the fluid from the media, after which the pressure may be reduced to the vacuum normal for this type of filter. In tests conducted on the material, repeated washings and regenerations have led to no detectable decrease in the operating characteristics of the filters.

It has been found that the HEPA filter of the co-pending application can also be utilized to remove mercury entrained in the exhaust stream. Mercury is present in many exhaust streams either as mercury vapor or physically or chemically attached to particulates within the stream. HEPA filters currently known to the art are not capable of trapping mercury in such form. On the other hand, filters capable of trapping mercury, such as those described above, are not suitable for use in exhaust stacks. Moreover, such filters cannot be cleaned or regenerated in situ. Such filters must therefore be replaced when they become saturated, a procedure that requires the expenditure of time and resources, as well as interrupting the operation of the exhaust stack itself.

The sintered HEPA filter of the current invention has been shown to reduce the amount of mercury on the effluent side of the filter medium by a factor of seven, as compared with HEPA filters currently known to the art. This represents a significant reduction in the amount of mercury present in the exhaust stream.

Moreover, unlike mercury filters known to the art, the filter according to the current invention can be cleaned and regenerated in situ. Although the exact mechanism is not known, it appears that mercury and particulates in the exhaust stream are not absorbed or adsorbed by the filter medium. The mercury and particulates are trapped on the influent surface of the filter medium. The influent side of the medium can therefore be cleaned without removing the filter from its operating location.

The cleaning process is carried out by a system in which standard, relatively inexpensive fluid nozzles or jets are placed in the HEPA assembly and directed to the influent side of the filter medium. The jets are connected to a source of fluid and a pump or similar mechanism for providing the fluid under pressure. Periodically, or as needed, the exhaust stack in question is bypassed or shut down so there is no flow of exhaust gases. A cleaning fluid is then pumped through the nozzles or jets such that the fluid impacts the influent side of the medium. This action strips the particulates and mercury from the influent side of the filter medium. The fluid can be selected as desired depending on the types of particulates present. It has been found that nitric acid is particularly effective in removing the mercury from the filter medium.

A catch basin, trough, or similar device can be located at a point below the filter to collect the fluid containing the mercury. The fluid can be drawn off from the catch basin for storage, disposal, and/or testing.

The residual fluid on the filter medium is then removed. It has been found that subjecting the filter medium to a vacuum on the order of 105 kPa (421 inches water column) will effectively remove all of the residual fluid from the medium. The cleaned and regenerated filter is restored to a full flowthrough capability with no detectable decreases in the operating characteristics thereof.

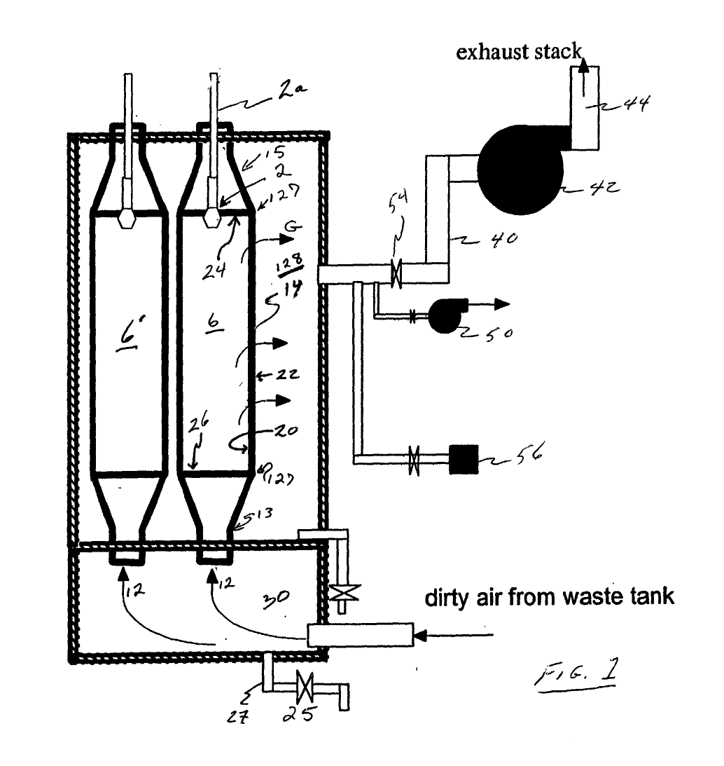

A preferred embodiment of a HEPA filter and HEPA filter assembly according to the invention is shown in FIG. 1. FIG. 1 is a cut-away diagram of a preferred assembly having two metal HEPA filter assemblies 6 and 6′. The two assemblies 6 and 6′ are identical in this embodiment, and reference hereafter is to assembly 6 for convenience. Filter assembly 6 comprises a filter medium 14 constructed as described above, that is, it is composed of stainless steel particles or pellets (not shown) of a one micron (1.0 μ) size, that are sintered together to form the stainless steel filter medium 14. Filter medium 14 has micro-pores of an approximate diameter of 0.2 micron (0.2 1 μ). The stainless steel sintered material with 0.2 μ porosity is available from commercial vendors such as Mott Metallurgical Corporation, Farmington, Conn.

The stainless steel filter media 14, having an effective porosity of 0.2 micron, was manufactured specifically for the embodiment described herein. The stainless steel filter media 14 is formed into a very thin sheet having uniform porosity across the surface thereof. The sheet can have a thickness in the range of from about 0.033 cm to about 0.12 cm (0.013 to 0.047 inches). Experiments conducted by the inventor hereof, for example, were completed using a filter having a thickness of approximately 0.12 cm (0.047 inches).

Although the filter media may be made and used as a sheet, it is preferred that the filter be formed into a cylinder as shown in cross-section in FIG. 1 to take advantage of the mechanical strength afforded by such a shape. The cylinder is hollow, thus having an interior side designated at 20 and an exterior side designated at 22, and ends 24 and 26. In the preferred embodiment according to this invention as shown in FIG. 1, the interior 20 of the cylinder forms the influent side of the filter, that is, the “upstream” side of the filter. The exterior 22 of the cylinder is thus the effluent, or “downstream,” side of the filter media.

In the preferred embodiment illustrated in FIG. 1, the two filter assemblies 6, 6′ are situated within a vacuum plenum 128. While FIG. 1 illustrates the use of two filter assemblies, a plenum can be provided with one or a plurality of such assemblies. The number of assemblies within the plenum will be determined by well-known considerations such as the size of the plenum and/or exhaust stream, the space available within the exhaust stack, and other factors. With reference again to filter assembly 6, assembly 6 is attached (as by, e.g., welding) to vacuum plenum 128. Filter medium 14 is provided with an end piece 15, preferably made of nonporous stainless steel. End piece 15 is affixed to medium 14 preferably by welding as indicated at 127. End piece 15 is attached to plenum 128, also preferably by welding.

A similar end piece 13 is affixed, again preferably by welding, to the other end of filter medium 14. End piece 13 is also attached to form an air-tight seal with plenum 128. End piece 13 is provided with a hole or opening 12. Opening 12 permits fluid communication between an intake plenum 30 and the interior of filter assembly 6. Intake plenum 30 is in turn in communication with a source of fluid to be filtered, such as dirty air from a waste tank.

Vacuum plenum 128 is connected by conventional means such as pipes or tubing 40 to a vacuum means such as a conventional pump 42. It is preferred that pump 42 be a high-flow, medium-vacuum pump. This takes advantage of the strength of filter medium 14, allowing a relatively high pressure drop across the medium during normal operations. Pump 42 operates to draw fluid from vacuum plenum 128 and exhaust the fluid into a conventional exhaust stack such as stack 44. Thus, fluid to be subjected to HEPA filtering is drawn from a source such as a waste tank (not shown) into an intake plenum 30. The fluid is drawn through opening 12 into the interior of filter assembly 6. The fluid is filtered across filter medium 14 into vacuum plenum 128 from which it is withdrawn by a pump 42 and exhausted.

Although FIG. 1 as depicted illustrates two filter assemblies 6 and 6′, there may be only one or several filters located within the plenum area 128. In the system according to the current invention, the filter assemblies can be cleaned and regenerated on any desired schedule. Means for cleaning the filters, in a preferred embodiment and again referring for convenience only to filter assembly 6, take the form of a fluid nozzle 2, mounted in any known fashion, set to direct a stream of fluid at a preferably oblique angle against the influent side of filter medium 14. A conduit 2a connects nozzle 2 to a source of desired fluid (not shown). Typical cleaning fluids may be any fluid suitable for the particulates being cleaned, the materials from which the filters are made, and as required by other considerations. The nozzle 2 may be connected in a serial fashion (not shown) to more than one source of fluid. For removing mercury from the filters, at least one of these fluid sources is preferably a fluid containing nitric acid.

To clean the filter medium 14, normal operation of the exhaust stack and filter assemblies is halted. Cleaning fluid is sprayed from nozzle 2 against the influent side of filter medium 14, removing mercury and other contaminants trapped on the influent side. The fluid sprayed from nozzle 2 may be a single type of fluid or may be different fluids applied sequentially. The type of fluid to be applied will be known to those of skill in the art taking into account such factors as the type of contaminants expected, the materials of the filter assembly, and other factors. It has been found that anitric acid solution is effective to quantitatively remove mercury from the filter medium. The fluid and contaminants may be collected in any known fashion. In the embodiment depicted in FIG. 1, the cleaning fluid and contaminants drain through opening 12 into plenum 30, from which it can be collected through a conduit 27 having a collection valve 25. The fluids can be drawn off for disposal, analysis, or sampling as desired.

After cleaning with fluid, the regeneration of filter medium 14 can be completed. HEPA filters known to the art must be passively dried. The application of sufficient pressure to remove liquid in the filter medium results in damage to the medium such that it will no longer function to the required HEPA standards. With the filter medium of the current invention, however, high pressure can be utilized to dry the filter. In the embodiment according to FIG. 1, vacuum plenum 128 is also connected to a low flow, high pressure pump 52 via tubing 40. A valve 54 is closed and pump 52 is activated to create a relatively high vacuum in vacuum plenum 128. This vacuum removes fluid from filter medium 14. Experimental work has shown that vacuums as high as 105 kPa can be applied. The experiments also show that the filter medium 14 can be repeatedly cleaned and dried without loss of filtering capability. Once the filter medium 14 is dry, the high vacuum is relieved by any conventional means, such as a vacuum breaker 56. Valve 54 can then be re-opened, and filtering of a waste stream can be resumed.

The components of the system described above should be constructed to withstand the high pressure drops (vacuums) needed to practice the cleaning and regeneration made possible by this invention. The process operating vacuum for such a system will be very similar to that using standard HEPA systems. These systems expect a pressure drop of from zero (0.0) to 1.5 kPa (0.0-6″ water column) across the filter media. In the system shown in FIG. 1, then, the various components must be capable of withstanding a vacuum of from 0.0 to 3.0 kPa (0- 12″ water column). The vacuum plenum 128 and the filter assemblies according to the invention, must be able to withstand the 40 kPa operating vacuum and the 105 kPa regenerating vacuum.

The exact requirements for the vacuum pump and other parts of the system can easily be determined by those of skill in the art. There will be some increased needs with the system of the claimed invention. In a standard exhaust gas stream, for example, it was found that a flow of 0.235 cubic meters per second (500 cfm) required a 0.75 kW (1.0 HP) pump. In the system of the invention, the same flow requires a pump rated at about 18.6 kW (25 HP).

The system of the invention makes possible a monitoring process heretofore impossible. That is, the particulates in an exhaust stream, for example, can be assayed on a periodic basis, or whenever desired. The process consists of filtering a stream for a desired period of time, thus collecting particulates on the HEPA filters of the invention. At a determined time, the filters are washed by directing fluid against the influent sides. The fluid and particulates, including mercury, are collected in a collection system, which may take any known form. The fluid with the particulates is drawn off and it, or an aliquot, are assayed. In the meantime, the HEPA filters are quickly regenerated by application of high vacuum, and the filtration system can be operating.

The media of the current invention has shown particulate collection efficiencies of up to 99.99%, as measured using 0.3 μ AED of DOP. The media can be made with materials other than stainless steel, and other porosities are within the metes and bounds of the invention so long as the definition of a HEPA filter is met.

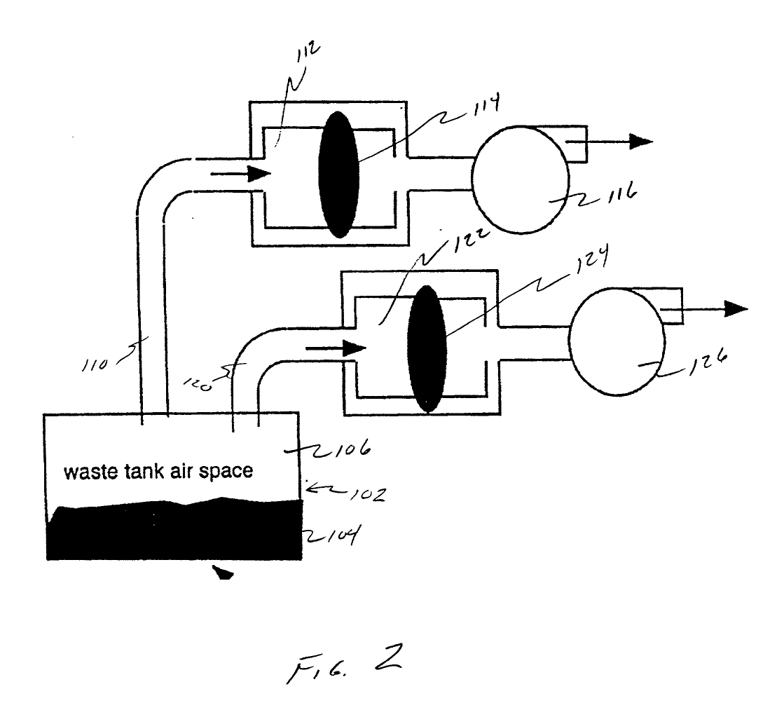

FIG. 2 illustrates diagrammatically an apparatus used to experimentally determine the efficiency of the removal of mercury from a gas stream utilizing the apparatus of the current invention. FIG. 2 illustrates a waste tank 102 containing waste 104 and having an air space 106 above the waste. A conduit 110 permits air to be withdrawn from air space 106 and introduced to a filter chamber 112. The filter chamber 112 had a standard glass paper HEPA filter 114 placed therein. Filter 114 had a diameter of about 8.0 cm (3 inches). Air flow through filter 114 was provided by pump 116. Another conduit 120 connected air space 106 with a second filter chamber 122. A sintered HEPA filter 124 according to this invention was placed within filter chamber 122. This filter also had a diameter of about 8.0 cm (3 inches). A second pump 126 provided air flow from air space 106 and through filter 124.

The presence and amount of mercury was measured at various points in the experimental system shown in FIG. 2. The results are shown in Table I below. The data in Table I show that the glass paper filter 114 of FIG. 2 had a mercury capture rate of 6.13×10⁻³ mg/3, while the sintered metal HEPA filter had a mercury capture rate of 4.51×10⁻³ mg/3. The mercury capture rate of the sintered metal HEPA filter was thus shown to be 7.37 times the mercury capture rate of the glass paper filter.

TABLE I
May 1998 “in-tank” headspace vapor sampling

| | | | |
|---|---|---|---|
| Metal filter air sample volume = | 2.80E+01 | FT\hat{ }3 | Mid tank Level Results (WSRC) |
| | 7.93E+05 | ml | |
| Paper filter air sample volume = | 2.45+01 | FT\hat{ }3 | Mid tank Level Results (WSRC) |
| | 6.94E+05 | ml | |

Mercury concentration @ mid tank level via Air Tubing (Paper Filter)

| | | | | |
|---|---|---|---|---|
| Lower sample tube section (14″ long) = | 3.26E+00 | μg | or | 2.33E−01 |
| Upper sample tube section (14″ long) = | 2.50E−01 | μg | or | 1.79E−02 |
| Average Hg per inch of air sample tube = | 0.125 | μg | | |
| Air assembly tube length = | 2.76E+02 | inches | | |
| Total mercury of sample tube = | 35 | μg | | |
| Total mercury of filter paper = | 4.25E−01 | μg | | |
| Total mercury of mid level sample = | 35.02 | μg | | |
| Airborne mercury @ mid-level = | 0.000050 | μg/ml | | |
| Airborne mercury @ mid-level | 0.050 | mg/m\hat{ }3 | Mercury | |
| Threshold mercury concentration limit = | 1.00E−01 | mg/m\hat{ }3 | | |
| Mercury capture rate on paper filter = | 6.13E−04 | mg/m\hat{ }3 | | |

Mercury concentration @ mid tank level via Air Tubing (Metal Filter)

| | | | | |
|---|---|---|---|---|
| Lower sample tube section (14″ long) = | 3.26D+00 | μg | or | 2.33E−01 |
| Upper sample tube section (14″ long) = | 2.50E−01 | μg | or | 1.79E−02 |
| Average Hg per inch of air sample tube = | 0.125 | μg | | |
| Air assembly tube length = | 2.76E+02 | inches | | |
| Total mercury of sample tube = | 35 | μg | | |
| Total mercury of filter paper = | 3.58E+00 | μg | | |
| Total mercury of mid-level sample | 38.18 | μg | | |
| Airborne mercury @ mid-level = | 38.18 | μg/ml | | |
| Airborne mercury @ mid-level = | 0.000048 | mg/m\hat{ }3 | Mercury | |
| Threshold mercury concentration limit = | 1.00E−01 | mg/m\hat{ }3 | | |
| Mercury capture rate on metal filter = | 4.51E−03 | mg/m\hat{ }3 | | |
| Ratio of mercury capture on metal vs. paper = | 7.37E+00 | | | |

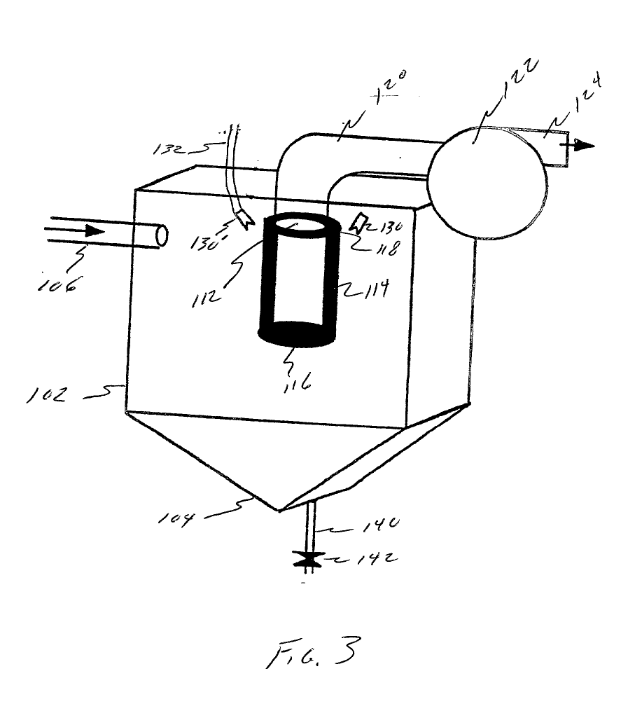

An alternative embodiment of a filter system according to the current invention is shown in FIG. 3. In this embodiment, there is shown an intake plenum 102 having a depression or trough 104 at the bottom thereof. A fluid waste stream from a source of waste (not shown) enters plenum 102 through a conduit or pipe 106. Within plenum 102 is at least one filter medium 114 formed of the sintered material described above shaped as a cylinder. A first end of the cylinder of filter medium 114 is closed by an endpiece 116, which is preferably formed of stainless steel and is preferably attached to filter medium 114 by welding. A second endpiece 118 is attached to a second end of the cylinder. Second endpiece 118 is provided with an opening 112. Endpiece 118 may be attached to a portion of plenum 102, or may be attached directly to an outlet pipe or conduit 120. Conduit 120 is in turn in communication with a pump 122, which has a discharge pipe or conduit 124 connected to an exhaust stack (not shown). Pump 122 may be a pump capable of both medium and high vacuum, or may represent two or more pumps such as shown in FIG. 1.

In this embodiment, the exterior of filter medium 114 is the influent side. Positioned around filter medium 114, one or more spray nozzles 130, 130′ are positioned to direct fluid against the exterior influent side of filter medium 114. Depending on the exact configuration of filter medium 114, there may be one or a plurality of spray nozzles. The spray nozzle or nozzles 130, 130′ are connected to a source of fluid (not shown) by fluid conduit or pipe 132.

In the embodiment illustrated in FIG. 3, mercury and particulates in the waste stream are drawn into plenum 102 and collected on the exterior influent side of filter medium 114. Periodically, or as needed, the waste stream flow is stopped. Fluid from nozzles 130, 130′ is sprayed against the exterior influent side of filter medium 114 to remove mercury and particulates. The fluid drains into trough 104, where it may be drawn off by waste pipe 140, which is controlled by valve 142.

The current invention provides many advantages while using simple and well known components to form a regeneratable filter system capable of significant removal of mercury. HEPA filters of the current invention do not need to be removed for cleaning or regenerating. This eliminates the normal downtime for an exhaust stream system, reduces personnel exposure to contaminating (and perhaps radioactive) particulates, and eliminates the complicated systems needed for backwashing.

The particular embodiments described herein are not intended to limit the scope of the invention. The sintered filter medium described herein may be formed into any convenient shape. It is sufficiently strong that it may be formed as a flat or curved sheet. The precise shape of the filter medium, the type of fluid nozzles selected, and other attributes of the system will be dependent on the particular exhaust stack and factors such as the amount and type of contaminants and the flow volume of the waste stream. Thus, many variations to the described embodiment are possible without departing from the scope of the invention.

Many variations of the described invention are possible while remaining within the scope of the disclosure. Those of ordinary skill in the art will be able to optimize the various components of the system and the assembly thereof, such as the mounting of the spray nozzles. The scope of this invention is thus to be measured only by the claims, which are set forth as follows.

What is claimed is:

1. A filter system for removing mercury entrained in an air stream, said system comprising:
a HEPA filter comprising a thin sheet formed of sintered particles, said particles having a size of approximately 1.0 μ, said filter having an influent side and an effluent side;
a cleaning system for said filter, said system comprising means for spraying said influent side of said filter with a fluid; and
means for creating a high pressure drop across said filter.

2. The filter system according to claim 1, wherein said fluid comprises nitric acid.

3. The filter system according to claim 1, wherein said influent side of said HEPA filter has an effective porosity of about 0.2 μ.

4. The filter system according to claim 1, wherein said HEPA filter has a gas flow-through rate of about 0.00017 m³ per second per 0.006 square meters (0.36 cfm per square inch) at an applied vacuum of about 40 kPa (160 inches water column).

5. The filter system according to claim 1, wherein said HEPA filter has a filtration efficiency of at least 99.97% for 0.3 μ AED using DOP aerosol.

6. The filter system according to claim 1, wherein said HEPA filter has a thickness in the range of from about 0.033 cm (0.013 inches) to about 0.12 cm (0.047 inches).

7. A method for periodic monitoring of a gas stream for the presence of mercury using an in situ filter system, said method comprising:
providing an in situ filter system for said stream, said system comprising:
a HEPA filter, said filter having an influent side and an effluent side, said influent side having an effective pore size of about 0.2 μ;
means for cleaning said filter by directing at least one fluid comprising nitric acid against said influent side of said filter to remove particulates therefrom; and
means for collecting said fluid and said mercury;
periodically activating said means for cleaning;
collecting said fluid and said mercury from said means for collecting; and
analyzing said mercury to monitor said gas stream.

8. A HEPA filter for use with a high pressure evacuation pump, said filter comprising:
a cylinder formed of a filter media, said cylinder having an interior, an exterior, and first and second ends, said filter media comprising sintered stainless steel particles, said particles having a diameter of about 1.0 μ, said media having a thickness in the range of from about 0.033 cm (0.013 inches) to about 0.12 cm (0.047 inches);
a first gas impermeable endpiece affixed to and closing said first end; and
a second gas impermeable endpiece affixed to said second end, said second endpiece having an opening therein, said opening adapted to connect to said high pressure evacuation pump.

9. The HEPA filter according to claim 8, wherein said exterior has an effective porosity of about 0.2 μ.

10. The HEPA filter according to claim 8, wherein said evacuation pump is capable of creating a vacuum of about 105 kPa (421 inches of water).

11. A filter system for removing mercury from a gas exhaust stream capable of in situ regeneration comprising:
a vacuum plenum;
an intake plenum;
a HEPA filter formed into a cylinder, said cylinder having an interior influent side and an exterior side and first and second ends, said filter comprising sintered stainless steel particles, said particles having a diameter of about 1.0 μ;
a first endpiece connecting said first end of said cylinder to said vacuum plenum;
a second endpiece attached to said second end of said cylinder, said second endpiece having an opening therein in communication with said interior influent side of said cylinder and with said intake plenum;
a vacuum pump connected to said vacuum plenum, said pump capable of creating a vacuum of about 105 kPa (421 inches of water); and
at least one fluid nozzle capable of directing fluid against said interior influent side of said cylinder; and
a source of fluid operatively connected to said at least one fluid nozzle.

12. The filter system according to claim 11, wherein said filter has a particulate filtration efficiency of about 99.99% of 0.3 μ AED using DOP aerosol.

13. The filter system according to claim 11, wherein said filter has a flowthrough rate of about 0.00017 cubic meters per 0.006 square meters (0.36 cfm per square inch) at 40.0 kPa (160 inches of water).
